(19) United States
(12) Patent Application Publication
(10) Pub. No.: US 2008/0157561 A1
(43) Pub. Date: Jul. 3, 2008

(54) Wind Repelling System for a Vehicle

(76) Inventor: Manfred Farber, Wielenbach (DE)

Correspondence Address: DICKINSON WRIGHT PLLC, 1901 L. STREET NW, SUITE 800, WASHINGTON, DC, 20036, US

(21) Appl. No.: 11/813,055

(22) PCT Filed: Dec. 12, 2005
(86) PCT No.: PCT/DE05/02231

§ 371 Date: Jun. 28, 2007

(30) Foreign Application Priority Data
Dec. 30, 2004 (DE) 10 2004 063 799.7

(51) Int. Cl. B60J 9/04

(52) U.S. Cl. 296/180.5

(57) ABSTRACT

The invention relates to a wind repelling system (18) for a vehicle, comprising a cross strut which is movable between a retracted neutral position and a deployed operating position, at least one adjusting lever arrangement (22) that is disposed between the cross strut (20) and a basic structure (26) while being provided with a deployment lever (32) and preferably an auxiliary guiding element (48). The deployment lever (32) and the auxiliary guiding element (48) are each hinged to the cross strut (2) via sliding/swivel joints (34, 52), each of which is loaded by a deployment spring (42,54) in order to deploy the wind repelling system. The deployment lever (32) is hinged to the basic structure (26) via a swivel joint (36) to which a lifting spring (56) is allocated. The lifting spring (56) raises the deployment lever (32) from a position in which the deployment lever (32) rests on the basic structure (26) to such an extent that the deployment springs (42, 54) can become effective.

This invention relates to a wind repelling system according to the preamble of claim 1, which is adjustable between a retracted inoperative position and a deployed operating position.

Wind repelling system configurations of this type, for example, are provided at the front edge of a roof opening, which is lockable by means of a sliding cover or similar lockable roof opening, in order to deflect the air flow flowing over the vehicle roof while driving the vehicle, in order to reduce the wind noise created when driving the vehicle with opened sun roof and to suppress the generally very disturbing “thudding” passenger's feel with the open sun roof.

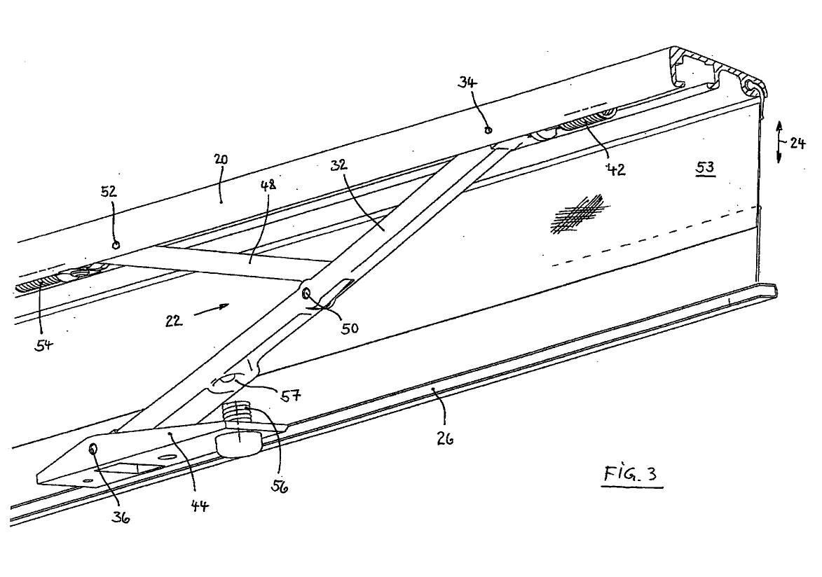

Another use of wind repelling systems, comprising a similar design, is an anti-buffet screen used in convertibles, in which between the front seats and the rear seats a wind shield consisting of a flexible material, a net or similar, can be installed. This type of wind repelling system configuration is known from DE 102 39 197 A1, particularly FIG. 3. It comprises a cross strut, which is adjustable by means of an adjusting lever arrangement between an retracted inoperative position and a deployed operating position, and can be mounted by means of a roll-up sunscreen. The adjusting lever arrangement comprises a deployment lever, which runs diagonally in operating position, which, on the one hand, is hinged at a basic structure formed by a roll-up sunscreen box, and on the other hand is hinged at the auxiliary guiding element and the deployment lever, the end of which, facing away from the deployment lever, is movable at the basic structure. The deployment lever is designed as a telescopic lever, so that the end of the pure vertical motion of the cross strut, which is hinged at the cross strut, can be moved into the inoperative position and/or operating position, and does not make an arc. The known wind repelling system also is arrested in inoperative position by means of an electrical adjustment of the end of the auxiliary guiding element facing away from the deployment lever.

In terms of design and structure, the known wind repelling system is relatively costly and less suitable, especially because of the required electrical drive and the necessary installation space for the wind repelling systems, which are to be configured in the area of the front edge of a roof opening.

The wind repelling system (refer, for example, to DE 199 58 742 A1), which is provided for installation in the area of the front edge, generally, when closing the cover are pushed by the adjustable cover against the force of the deployment spring into its off position and/or are released when opening the cover, so that said springs move towards their operating position under the effect of the deployment spring. With the adjusting configuration of the above-described type, however, there is a difficulty of disposing of the deployment springs in such a way that they are effective not only during the entire phase of the adjusting motion of the wind repelling system, but also are accommodated in an esthetically appealing manner, i.e., they are hidden.

It is the object of the present invention to create a wind repelling system of the type prescribed in the preamble of Claim 1, which is moved by the spring force into its operating position and enables a largely hidden configuration of the required springs across the entire adjusting phase.

According to the foregoing, this object is achieved according to the invention by means of the characteristic features described in claim 1. Preferred embodiments of the invention are described in the subordinate claims.

In order to load the wind repelling system in the deployment direction through a window, it is provided according to the invention that a swivel joint of the deployment lever is designed as sliding/swivel joint and is impinged by a first deployment spring acting in the direction of adjustment, which exerts a force on the sliding joint in the sense of a deployment motion of the wind repelling system. Since the sliding joint however takes on a dead center position at the inoperative position of the wind repelling system, so that the effective direction of the deployment spring has no effective power components acting transversely to the deployment lever, it also is provided that a lifting spring is allocated to the second swivel joint of the deployment lever, which, during the adjustment of the wind repelling system, automatically is tensioned by the deployment lever in the inoperative position by means of the deployment lever, and consequently is loaded while the wind repelling system is in inoperative position.

Depending on the selected configuration of the sliding/swivel joint, the deployment spring can be hidden by a simple method for the deployment lever at the cross strut or at the basic structure, in which a sufficient installation space is available also for longer springs.

The lifting spring serves to adjust the adjusting lever arrangement from the inoperative position only to the point at which the deployment spring becomes effective. According to an embodiment of the invention, it therefore is provided that the deployment lever comes to rest against the deployment spring in the inoperative position only during a end phase of the adjustment of the wind repelling system, i.e., conversely becomes effective in operating position only during the starting phase of the adjustment of the wind repelling system. The lifting spring, therefore, must only have a short spring path, so that said spring may be small in design, which enables a hidden installation.

In the case of a structural embodiment of the wind repelling system according to the invention, it is provided that the lifting spring is a spiral compression spring at which lies the deployment lever. The spiral compression springs are very simple, and therefore are low-cost components that are available in the market in almost any designs and dimensions.

In a further structural embodiment of the wind repelling system according to the invention, it is provided that a bearing block is arranged at the component, which is allocated to the second swivel joint, which carries said swivel joint and the lifting spring. This bearing block, for example, can be installed in the vehicle as a pre-assembled unit.

In order to ensure that the lifting spring, which is designed as a spiral compression spring, are held safely at the allocated deployment lever, according to another embodiment of the invention, a recess is provided at the deployment lever in order to accommodate and laterally fix the end of the spiral compression spring turned towards the deployment lever.

A further favorable embodiment of the invention provides that the sliding/swivel joint of the auxiliary guiding element is loaded by a second deployment string acting in the direction of adjustment, said spring having a loading effect on this sliding/swivel joint in the sense of a deployment motion of the wind repelling system. By this method, the required deployment force can be distributed to two deployment strings, which are dimensioned correspondingly small, and therefore can easily be installed in the available installation space.

In a wind repelling system provided for the front edge of a roof opening, it is provided that the deployment lever is located via a swivel joint at the front cowl of the vehicle roof and via the sliding/swivel joint at the cross strut. The auxiliary guiding element preferably is one-armed and located via a swivel joint approximately in the area of the center of the deployment lever and via a sliding/swivel joint at the cross strut. The first deployment spring allocated to the deployment lever and the second deployment spring allocated to the auxiliary guiding element have improved and opposite effective directions, which are explained in detail by means of an embodiment.

The cross strut is formed in a known manner as an aerodynamic wing or similar, which effects the desired deflection. According to a preferred embodiment of the invention, the cross strut—where appropriate necessarily—serves to mount a flexible tissue, i.e., a similar tissue is arranged between the cross strut and the basic structure, which is mounted in the operating position of the wind repelling system between said struts.

An embodiment of the invention is shown in the drawing, and is explained in detail in the following. Of the drawing:

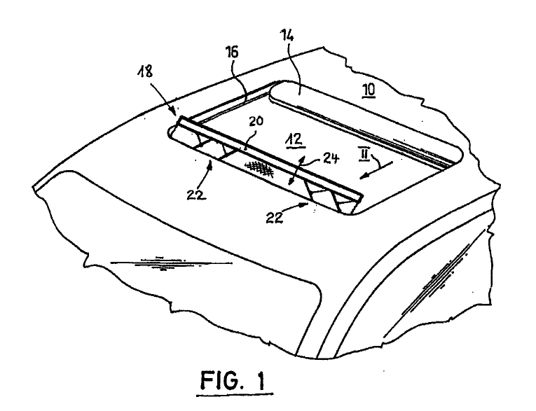

FIG. 1 shows a perspective view of a vehicle roof with a deployed wind repelling system according to the invention,

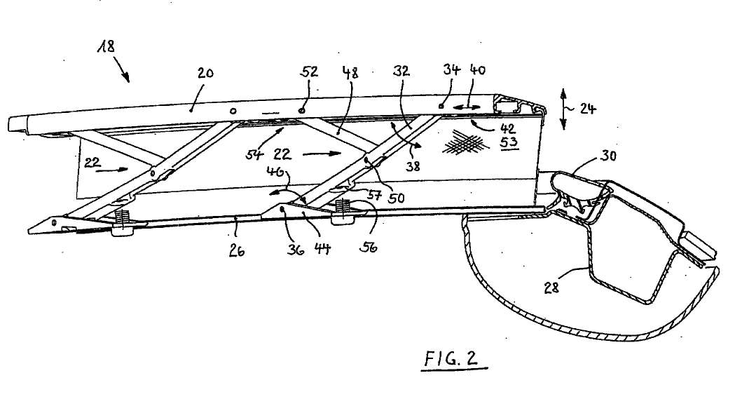

FIG. 2 shows a part of the wind repelling system according to FIG. 1 in a view according to arrow 11 in FIG. 1,

FIG. 3 shows a view corresponding to FIG. 2 as an enlargement, and

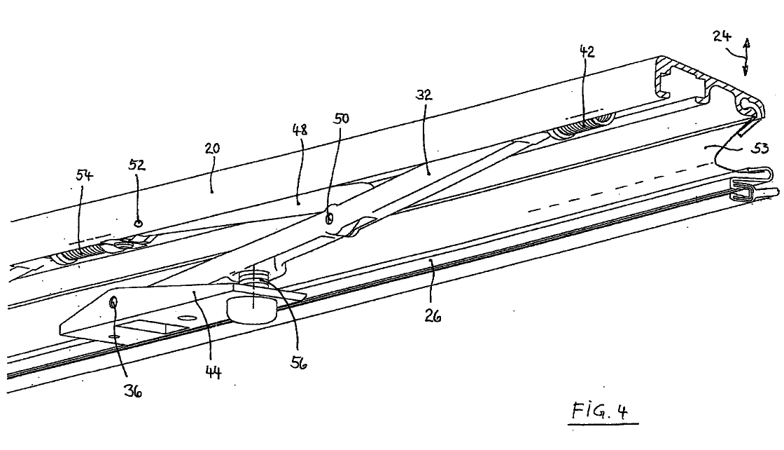

FIG. 4 shows a view according to FIG. 3 with partially retracted wind repelling system.

As indicated in FIG. 1, in a solid roof surface 10 of a vehicle roof a roof opening 12 is formed, which optionally can be closed by means of a cover 14, or at least can partially be released. The cover 14 is maintained laterally in a frame surrounding the roof opening 16. At the front edge of the roof opening 12, a wind repelling system is provided, which is presented between a retracted inoperative position in and/or behind the cowl formed by the front roof rail 28 and which is adjustable in the operating position deployed upward, which is shown in FIG. 1 to 3. This is a wind repelling system, which can be adjusted in its inoperative position when closing the cover 14 by means of said cover, which is not shown in detail. For this purpose, the cover 14 during the closing operation can be disposed from the top to a cross strut 20 of the wind repelling system 18 and presses said strut downward or laterally arranged levers (not shown) are arranged at the cross strut 20 onto which the cover 14 or parts coupled with said cover come to rest when closing the cover 14 and subsequently press said parts downward. Further, the wind repelling system 18 can be manually operated by vehicle passengers, as, for example, is described in German patent specification 10 2004 050 513.6-24, whose disclosure content hereby also becomes the subject matter of the present application.

The wind repelling system comprises a cross strut 20 via which several adjusting lever arrangements 22 can be adjusted in the direction of the double arrow 22 between an inoperative position retracted between the front roof and/or the cowl 28 and the operating position presented in FIG. 1. In FIG. 1 four adjusting lever arrangements 22 are provided, which are arranged in pairs and symmetrically towards a vertical longitudinal center place of the vehicle. Details of the adjusting lever arrangements 22 and their functionality are explained in greater detail by means of FIG. 2 to 4. A partial view shows a wind repelling system from FIG. 1 in the direction of the arrow 11, i.e., the left side of this wind repelling 18 is shown in a rear view. The cross strut 20 in its shown left half is adjustable via two equally formed adjusting lever arrangements 22 in the direction of the double arrow 24 and arranged at a basic structure 26, which is formed by the front roof rail 28 or the front cross-section of the frame 16 and/or at one of these components; because it conducts the wind above the windshield, the front roof rail 28 also is referred to as the cowl. The weather-strip 30 is allocated to the front roof rail 28 and/or cowl, at which the cover 14 (refer to FIG. 1) abuts in its closed position.

One of the similarly designed adjusting lever arrangements 22 is described in the following. Said configurations comprise a deployment lever, which is hinged via first swivel joint 34 at the cross strut 20 and via a second swivel joint 36 at the basic structure 26. The first swivel joint 34 is designed as a sliding/swivel joint, i.e., it enables swiveling the deployment lever 32 in the direction of the double arrow 38, and can be mounted in order to be moved in the direction of the double arrow 40 at the cross strut 20. The bearing point of the swivel joint 34, which is shown in FIGS. 2 and 3, is shown only as a schematic example. This is not a swivel axis mounted rigidly to the cross strut 20, but a mounted swivel axis to be moved within the hollow section of the cross strut 20, which is open towards the bottom, at a sliding element in the direction of the double arrow. In the following, the first swivel joint 34 also is referred to as sliding/swivel joint 34.

As is indicated in particular in FIGS. 3 and 4, the slide/swivel joint 34 is allocated a deployment spring 42, which acts in the sliding direction of the wind repelling system, i.e., in FIG. 3 it exerts a force towards the left. The second swivel joint 36 is a pure swivel joint. It is arranged at a bearing block 44 rigidly mounted with the basic structure 26, and it enables a swiveling motion of the deployment lever 32 in the direction of the double arrow 46.

The auxiliary guiding element 48 is approximately in the center of the deployment lever 32 above a second swivel joint 50. The end of the auxiliary guiding element 48 facing away from the swivel joint 50 can be sliding/swivel joint 52 similar to the sliding/swivel joint 34, and is hinged to the cross strut 20. A deployment spring 54 also is allocated to the sliding/swivel joint 52, which is effective in the sliding direction and exerts a force to the right on the sliding/swivel joint 52 in the sense of a deployment motion of the wind repelling system, i.e., as illustrated in FIG. 3.

The deployment levers 42 and 54 therefore have a tendency to adjust the cross strut 20 in FIG. 2 to 4 in the upward direction; this motion is limited by the tissue, for example, a cloth or net, which is arranged between the cross strut 20 and the basic structure 26, which thus is maintained in a mounted operating position by means of the deployment springs 42 and 54. However, additional stops in the hollow section of the cross strut 20, which, for example, limit the adjustment of at least one of the sliding/swivel joints 34 and/or 52 or the swivel motion at the swivel bearings 36 limiting the stops for a limitation of the deployment height of the wind repelling system 18. Preferably, these stops are adjustable so that the maximum deployment height of the wind repelling system 18 is adjustable for the varying roof types, vehicle types, or even traveling speeds.

When closing the roof 14, the wind repelling system 18 is adjusted manually or by the cover 14 via a known mechanical device (not shown) against the force of the deployment springs 42, 54 in their inoperative position, which are arranged behind or in front of the roof rail 28, in which the deployment lever 32 is applied to the basic structure 26 and the auxiliary guiding element 48 is applied to the cross strut 20, as indicated in particular in FIG. 4. Since the deployment springs 42, 54 in the inoperative position of the wind repelling system 18 essentially have no power components which act transversely towards the deployment lever 32 and/or towards the auxiliary guiding element 48, but assume a dead center position, said springs are unable to move the wind repelling system 18 upward from the inoperative position. For this reason, a lifting spring 58 is allocated to the second swivel joint 36 of the deployment lever 32, at which the deployment lever 32 moves in the inoperative position when adjusting the wind repelling system 18. As is shown in particular in a comparison of FIGS. 3 and 4, the lifting spring 56 preferably is so designed that the deployment lever 32 in inoperative position abuts the lifting spring 56 and tensions said spring only after a end phase of the adjustment of the wind repelling system 18. At the deployment lever 32, a recess 57 is formed, which accommodates the end of the lifting spring and secures against sliding. According to an alternative embodiment, the lifting spring 56, however, may also be formed by a swivel pin spring in the area of the swivel bearing 36 preferably covered, which preferably engages in the lower section of the deployment lever 32.

If the cover 14 is adjusted in its opening position, and releases the wind repelling system 18 for an adjustment in its operating position, the lifting spring 56 lifts the deployment lever 32 up to a position in which the deployment springs 42 and/or 54 respectively have a power component transversely to the deployment lever 32 and/or the auxiliary guiding element 48, which is sufficient to lift the wind repelling system 18 up to the de-activated operating position and stretch the wind repelling tissue 53.

As is indicated in FIG. 2 to 4, the cross strut 20 is formed downward as an open hollow section, so that the sliding/swivel joints 34/52 and the deployment springs 42 and/or 54 with the deployment lever 32—the latter being in the lowered inoperative position—are accommodated in the hollow section of the cross strut and thus can be hidden.

Furthermore, the deployment lever 32 preferably is formed upward as a hollow section, which accommodates the auxiliary guiding element 48 in the operative position. As a result, the optical appearance of the wind repelling system 18 is not impaired by the springs 42 and/or 54 and the inoperative position will require only a minor construction height, since all components of the adjusting lever arrangements 22 and the springs 42, 54, and 56 are accommodated in the section of the cross strut 20.

Between the cross strut 20 and the basic structure 26, a flexible tissue 53, for example, a net tissue, which, as shown in operating condition in FIGS. 2 and 3, is mounted and falls together adjustment to inoperative position is effected (refer to FIG. 4).

However, the invention can also be applied with a wind repelling system in which the cross strut 20 is formed as a deflector profile and is able to manage without such tissue 53.

### LIST OF REFERENCE SYMBOLS

10 Roof surface
12 Roof opening
14 Cover
16 Frame
18 Wind repelling system
20 Cross strut
22 Adjusting lever arrangement
24 Double arrow
26 Basic structure
28 Roof rail and/or cowl
30 Weather-strip
32 Deployment lever
34 First swivel joint
36 Second swivel joint
38 Double arrow
40 Double arrow
42 Deployment spring
44 Bearing block
46 Double arrow
48 Auxiliary guiding element
50 (additional) swivel joint
52 Sliding/swivel joint
53 Wind repelling tissue
54 Deployment spring
56 Lifting spring
57 Recess

1. A wind repelling system (18) for a vehicle, comprising a cross strut (20), which is adjustable between a retracted inoperative position and a deployed operating position, at least an adjusting lever arrangement (22) configured between the cross strut (20) and a basic structure (26) with at least one deployment lever (32), which is hinged via a first swivel joint (34) at the cross strut (20) and via a second swivel joint (36) at the basic structure (26), which in the operating position runs diagonally to the basic structure (26) and the cross strut (20) and abuts thereon in inoperative position, characterized in that one of the two swivel joints (34 and/or 36) of the deployment levers is formed as sliding/swivel joint and is impinged by a first deployment spring (42) exerting a force, which has an effect in the direction of adjustment loading the sliding/swivel joint (34 and/or 36) in the sense of a deployment motion of the wind repelling system (18), and that a lifting spring (56) is allocated to the other of the two swivel joints (34 and/or 36) of the deployment lever (32), which is tensioned by means of the deployment lever (32) when adjusting the wind repelling system (18) in the inoperative position.

2. A wind repelling system as defined in claim 1, characterized in that the adjusting lever arrangement (22) comprises an auxiliary guiding element (48), which is hinged at the deployment lever (32) via another swivel joint (50) and at the cross strut (20) or at the basic structure (26) via a sliding/swivel joint (52).

3. A wind repelling system according to claim 1 or 2, characterized in that only during the end phase of the adjustment of the wind repelling system (18) the deployment lever (32) reaches its inoperative position s a result of which the lifting spring (56) comes to a stop.

4. A wind repelling system as defined in one of the claims 1 to 3, characterized in that the lifting spring (56) is a spiral compression spring at which abuts the deployment spring (32).

5. A wind repelling system as defined in one of the claims 1 to 4, characterized in that the second swivel joint (36) is disposed at a bearing block (44) with the basic structure (26), at which the lifting spring (56) is supported.

6. A wind repelling system as defined in one of the claims 1 to 5, characterized in that the deployment lever (32) has a recess (57) for accepting and the lateral fixing of the ends of the lifting spring (56) facing the deployment lever (32).

7. A wind repelling system as defined in one of the claims 2 to 6, characterized in that the sliding/swivel joint (52) of the auxiliary guiding element (48) is loaded by a second deployment spring (54) acting in the direction of adjustment, which exerts a force on this sliding/swivel joint (52) in the sense of a deployment motion of the wind repelling system (18).

8. A wind repelling system as defined in one of the previous claims, characterized in that the basic structure (26) is disposed at the front roof rail (28) and/or at a front edge of the roof opening (12).

9. A wind repelling system as defined in one of the previous claims 2 to 8, characterized in that the auxiliary guiding element (48) is formed as a single arm and hinged via the second swivel joint (50) in the center area of the deployment lever (32).

10. A wind repelling system as defined in one of the previous claims 7 to 9, characterized in that the first deployment spring (42) is allocated to the deployment lever (32), and the second deployment spring (54) is allocated to the auxiliary guiding element (48) in the opposite effective directions.

11. A wind repelling system as defined in one of the claims 1 to 10, characterized in that several adjusting lever arrangements (22) are disposed adjacent to one another in the longitudinal direction to the cross strut (20).

12. A wind repelling system as defined in one of the claims 1 to 11, characterized in that the cross strut (20) is formed as a downward open hollow section and that the swivel joints (34, 52), which are allocated to the cross strut (20) and the deployment springs (42, 54), are disposed within the hollow section.

13. A wind repelling system as defined in one of the claims 1 to 12, characterized in that between the cross strut (20) and the basic structure (26) a flexible tissue (53) or similar is disposed, which is mounted in operating position of the wind repelling system (18) between said strut and structure.
